(19) United States
(12) Patent Application Publication
(10) Pub. No.: US 2019/0098118 A1
(43) Pub. Date: Mar. 28, 2019

(54) Repurposing Domain Name System as a Business Data Transport Layer

(71) Applicant: Nominum, Inc., Redwood City, CA (US)

(72) Inventor: Fendry Utama, Belmont, CA (US)

(21) Appl. No.: 15/718,547

(22) Filed: Sep. 28, 2017

(51) Int. Cl. H04L 29/08; H04L 29/12

(52) U.S. Cl. CPC H04L 69/324; H04L 61/2007; H04L 67/12; H04L 61/1511

(57) ABSTRACT

Provided are computer-implemented methods and systems for repurposing a Domain Name System (DNS) as a business data transport layer. An example method for repurposing the DNS as a business data transport layer includes collecting business telemetry data associated with an Internet of Things (IoT) device. The business telemetry data is collected by at least one telemetry sensor installed on the IoT device. The method further includes generating, by the IoT device, an Extended DNS (EDNS) packet. The EDNS packet includes a DNS address associated with a DNS server of a business data center associated with the IoT device manufacturer or supporting server and the business telemetry data stored in at least one extension field of the EDNS packet. The EDNS packet is then routed to the DNS server associated with the business data center of the IoT device manufacturer or supporting server as part of the DNS request.

### FIELD

This application relates generally to data processing and more specifically to systems and methods for repurposing a domain name system (DNS) as a business data transport layer.

### BACKGROUND

Conventionally, a DNS is used to resolve a domain name to an Internet Protocol (IP) address. An authoritative DNS name server is part of a hierarchical distributed naming system that maps certain resource identifiers such as IP addresses, to the domain names currently associated with the IP. Thus, the DNS resolves queries for domain names to IP addresses in order to locate computer services and devices worldwide. The DNS effectively translates human-friendly domain names into IP addresses.

The adoption of Extension of mechanisms for DNS (EDNS) has enabled additional functionality for the DNS transmissions. EDNS extension fields in a DNS packet were intended to solve some networking challenges at the DNS level. For example, before the EDNS was implemented, it was difficult to identify a device generating a DNS request if the device is located behind a firewall. With the EDNS, an extension field can be used to store a Media Access Control (MAC) address of a device generating a DNS request to enable identification of the device. There are other network challenges that can be solved at the DNS level using the EDNS extension fields. However, the EDNS extension fields were never intended for use or used to transport business application data.

Business application data, logistics, and/or telemetry data can include data measured and transmitted by sensors located in automobiles, smart meters, smart house appliances, power sources, robots and other objects which together constitute the Internet of Things (IoT). Conventionally, IoT devices, such as a smart industrial fridge/freezer, use MQ Telemetry Transport (MQTT) or Hypertext Transfer Protocol (HTTP) to send and receive data. Thus, traditionally, data transmission process from an IoT device to a data server involves two steps. First, a DNS request is resolved to an IP address. Then a MQTT or an HTTP session is initiated to transport the business data. However, in case of a great number of IoT devices (e.g., all light bulbs in a skyscraper), exchanging data packets via MQTT or HTTP data session requires a considerable bandwidth. In addition to requiring considerable bandwidth throughput, particularly, in order to support HTTP communications, IoT devices are required to store application libraries which could make be impractical in case of small IoT devices such light bulbs and too expensive to manufacture.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

Provided are computer-implemented methods and systems for repurposing a DNS as a business data transport layer. In some example embodiments, a method for repurposing a DNS as a business data transport layer may include collecting business telemetry data associated with an IoT device. The business telemetry data may be collected by at least one telemetry sensor installed on the IoT device. The method may further include generating, by the IoT device, an EDNS packet. The EDNS packet may include a DNS address associated with a business data center and the business telemetry data stored in at least one extension field of the EDNS packet. The method may continue with routing the EDNS packet as part of a DNS request sent to a DNS server associated with a business data center of the IoT device manufacturer or third-party support provider.

In some example embodiments, a system for repurposing a DNS as a business data transport layer may include a data aggregation module. The data aggregation module may be configured to receive, from a DNS server associated with a business data center, an EDNS packet forwarded to the DNS server by at least one telemetry sensor installed on an IoT device as part of a DNS request. The EDNS packet may include a DNS address associated with the business data center and business telemetry data stored in at least one extension field of the EDNS packet. The business telemetry data may be associated with the IoT device. The data aggregation module may be further configured to retrieve the business telemetry data from the EDNS packet and store the business telemetry data associated with the IoT device. The system may further include a database configured to store at least the business telemetry data associated with the IoT device.

According to another aspect of this disclosure, there is provided a non-transitory processor-readable medium having instructions stored thereon. When these instructions are executed by one or more processors, they can cause the one or more processors to implement the above-described method for repurposing a DNS as a business data transport layer.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

Exemplary embodiments are illustrated by way of example and not limitation in the figures of the accompanying drawings, in which like references indicate similar elements.

FIG. 1 illustrates an environment within which methods and systems for repurposing a DNS as a business data transport layer can be implemented, according to an example embodiment.

FIG. 2 illustrates a flow chart of a method for repurposing a DNS as a business data transport layer, according to an example embodiment.

FIG. 3 shows an EDNS packet, according to an example embodiment.

FIG. 4 is a block diagram of a system for repurposing a DNS as a business data transport layer, according to an example embodiment.

FIG. 5 illustrates a schematic representation of DNS packets.

FIG. 6 illustrates a schematic representation of DNS packets.

FIG. 7 is a computer system that can be used to implement a method for repurposing a DNS as a business data transport layer, according to an example embodiment.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, and other embodiments can be formed, by introducing structural and logical changes without departing from the scope of what is claimed. The following detailed description is, therefore, not to be taken in a limiting sense and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Provided are computer-implemented methods and systems for repurposing a DNS as a business data transport layer. According to these methods and systems, IoT devices may provide business telemetry data via a DNS payload (also referred herein to as an EDNS extension field) of an EDNS packet using a standard DNS protocol. The DNS address to which the IoT device may forward the EDNS packet may be associated with a manufacturer or another organization providing support for the IoT device. Thus, the EDNS packet may include both a DNS query (i.e., standard information conventionally sent in DNS packets) and the business telemetry data in the extension fields of the EDNS packet.

Similarly, the service provider may send, using one or more DNS servers, an EDNS packet to the IoT device. The EDNS packet sent by the service provider may contain both the DNS response (i.e., standard information conventionally sent in DNS packets) and an instruction or a command for the IoT device. The instruction or the command may be issued by the service provider based on the business telemetry data and included in the extension field of the EDNS packet sent by the service provider to the IoT device.

Both the business telemetry data in the extension fields of the EDNS packet sent by the IoT device and the instruction or the command in the extension field of the EDNS packet sent by the service provider may be obfuscated, e.g., using encryption. Therefore, the business telemetry data may be processed in out-of-band mode from any external process flow for the DNS protocol.

Thus, the extension fields in EDNS packets may be used to transport business telemetry data. Therefore, the use of the EDNS packet may go beyond the conventional networking and communication infrastructure protocol. The business telemetry data to be transmitted in the EDNS field can be related to the business practice of an organization and may be communicated between one entity to other entities in parallel to the standard functions of the DNS protocol.

Thus, the DNS protocol may be repurposed for transporting, along with conventional domain name to IP address translation data, non-network related information, such as any business application data, to an intended recipient. Example business application data can include business telemetry data transmitted by a plurality of IoT devices to a service provider using a DNS protocol.

The DNS platform is an integral part of the network infrastructure and the DNS protocol is simple, robust and scalable as is suitable for use with the present technology, according to various embodiments, to provide for transporting, mediating, and storing business application data for the IoT manufacturers. Additionally, all IoT devices, whether smart or not, have the basic capability to send a DNS query and process the DNS response. In contrast to the usage of the HTTP or another protocol by the IoT devices to communicate the business application data, the usage of the DNS protocol by the IoT devices may result in reduction in hardware (central processing unit (CPU), random access memory (RAM), and storage) requirements for managing operations of the IoT devices.

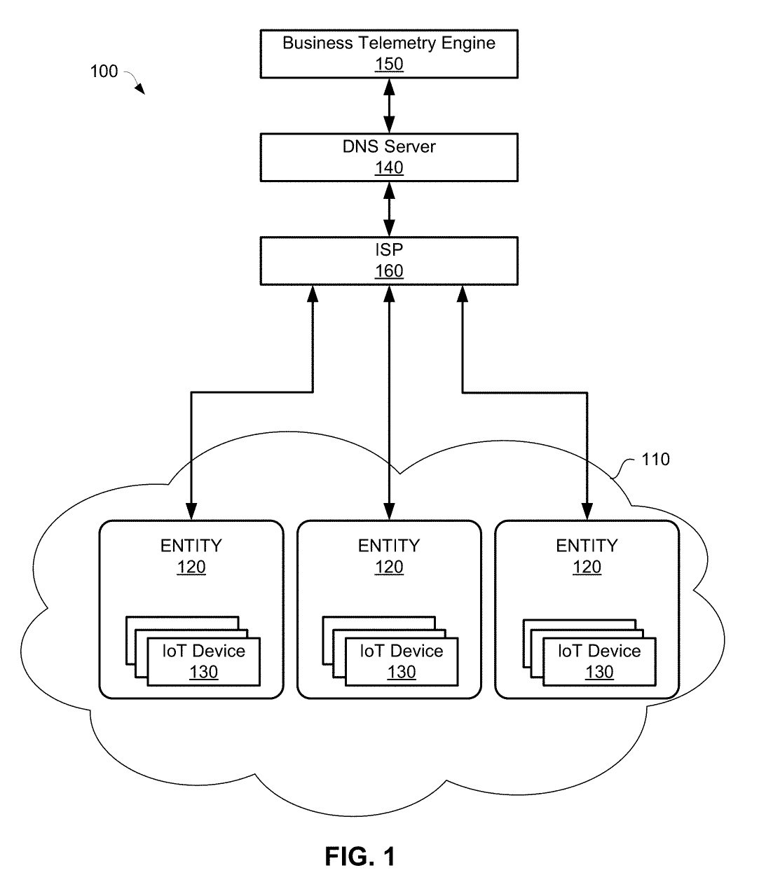

Referring now to the drawings, FIG. 1 illustrates an environment 100 within which methods and systems for repurposing a DNS as a business data transport layer can be implemented. The environment 100 may include a data network 110 (e.g., an Internet), a plurality of entities 120, a plurality of IoT devices 130 associated with each of the plurality of entities 120, an Internet Server Provider (ISP) 160, a DNS server 140, and a business telemetry engine 150. The plurality of entities 120 may include private houses, industrial facilities, municipal facilities, and any objects or locations in which the IoT devices 130 are installed. The IoT devices 130 may include any physical devices, vehicles, and other items embedded with electronics, software, and connectivity to the data network 110 to enable these items to collect and exchange data. The IoT devices 130 may be equipped with sensors (not shown) that may measure parameters associated with environmental conditions or an operation of the IoT devices 130.

Each of the plurality of IoT devices 130 may be configured to send, using a DNS protocol, business telemetry data (not shown) to the DNS server 140 in EDNS packets. The business telemetry engine 150 can be associated with a manufacturer (not shown) or a service provider (not shown) associated with the IoT devices 130. The business telemetry engine 150 may be configured to retrieve the business telemetry data from the DNS server 140. Specifically, the business telemetry engine 150 may be configured to connect to the DNS server 140 and retrieve EDNS packets received by the DNS server 140 via the DNS protocol. In a further example embodiment, the DNS server 140 is configured to automatically send the received EDNS packets or the business telemetry data contained in the EDNS packets to the business telemetry engine 150.

The data network 110 may include the Internet or any other network capable of communicating data between devices. Suitable networks may include or interface with any one or more of, for instance, a local intranet, a corporate data network, a data center network, a home data network, a Personal Area Network, a Local Area Network (LAN), a Wide Area Network (WAN), a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network can further include or interface with any one or more of a Recommended Standard 232 (RS-232) serial connection, an IEEE-1394 (FireWire) connection, a Fiber Channel connection, an IrDA (infrared) port, a Small Computer Systems Interface connection, a Universal Serial Bus (USB) connection or other wired or wireless, digital or analog interface or connection, mesh or Digi® networking. The data network 110 may include a network of data processing nodes, also referred to as network nodes, that may be interconnected for the purpose of data communication.

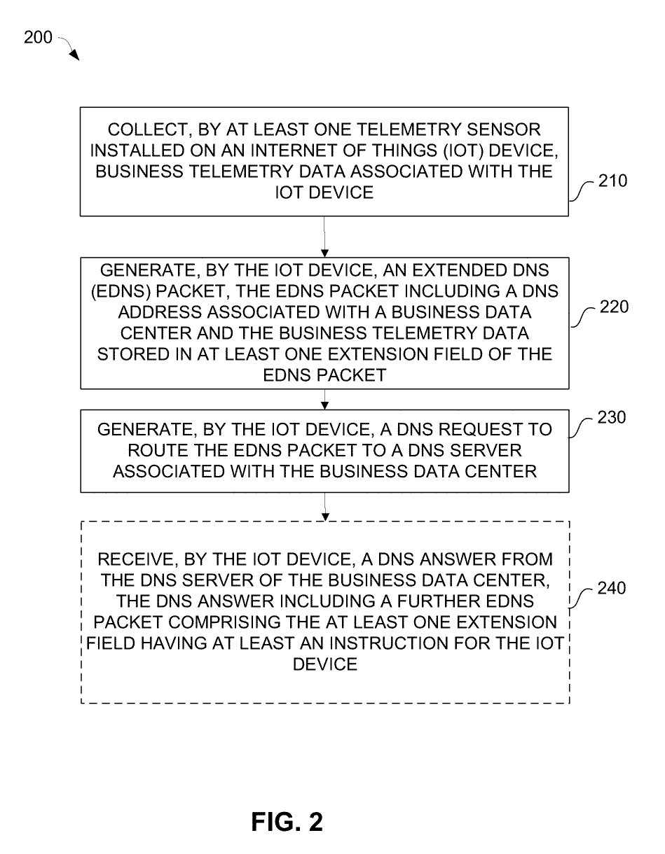

FIG. 2 shows a process flow diagram of a method 200 for repurposing a DNS as a business data transport layer, according to an example embodiment. In some embodiments, the operations may be combined, performed in parallel, or performed in a different order. The method 200 may also include additional or fewer operations than those illustrated. The method 200 may be performed by processing logic that may comprise hardware (e.g., decision making logic, dedicated logic, programmable logic, and microcode), software (such as software run on a general-purpose computer system or a dedicated machine), or a combination of both.

The method 200 may commence with collecting business telemetry data associated with an IoT device at operation 210. The business telemetry data may be collected by at least one telemetry sensor installed on the IoT device. In an example embodiment, the IoT device may be equipped with one or more sensors, such as telemetry sensor. The sensors may sense and collect business telemetry data related to the IoT device. Specifically, the business telemetry data may include one or more of the following: an IP address of the IoT device, an identification number of the IoT device, a parameter code of the IoT device, a value of a current parameter of the IoT device, a model of the IoT device, a firmware version installed on the IoT device, data concerning a quality assurance center that provides maintenance services for the IoT device, an operation start time, an operation stop time, a troubleshooting code, a geographical location of the IoT device, a brand of the IoT device, a price of the IoT device, a color of the IoT device, a current date, current time, a timestamp, and so forth. For example, in case the IoT device can include a smart industrial fridge/freezer that can be set to work as a fridge or as a freezer depending on current needs of a user, the business telemetry data may include values of current parameters, such as a current external temperature in a room where the IoT is located, a current internal fridge temperature, a current internal fridge moisture, a current internal freezer temperature, and so forth.

The method 200 may continue with generating, by the IoT device, an EDNS packet at operation 220. The EDNS packet may include a DNS address associated with a business data center and the business telemetry data stored in at least one extension field of the EDNS packet. Specifically, the IoT device may be connected to the data network and may be configured to use the DNS protocol to communicate with a DNS server associated with the business data center. In an example embodiment, the IoT device may include a DNS-client running on the IoT device. The IoT device may use the DNS-client to generate the EDNS packet and send the EDNS packet to the DNS server using the DNS protocol.

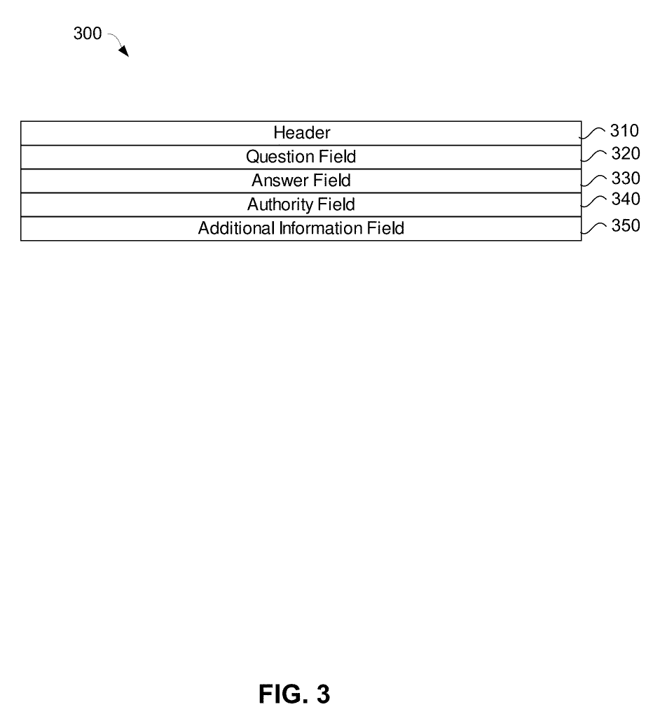

FIG. 3 shows an EDNS packet 300, according to an example embodiment. The EDNS packet 300 may have a header 310, a question field 320, an answer field 330, an authority field 340, and an additional information field 350. The header 310 is a standard header of a DNS packet. The question field 320 may include a string containing the Internet address being queried, a query type, and a query class. The answer field 330 may include the Internet address that is requested for in the question field 320. The authority field 340 may include the number of seconds that the data is to be cached by a client and the amount of space needed by a data resource.

Conventionally, the additional information field 350 in the EDNS packet 300 includes network-related information. However, according to various embodiments of the present disclosure, the additional information field 350 is included in an extension field of the EDNS packet 300 and is used for conveying the business telemetry data. In an example embodiment, the additional information field 350 has a length of 512 bytes.

In an example embodiment, the storing of the business telemetry data in the at least one extension field of the EDNS packet may include selecting, based on the business telemetry data, one or more data types to be included into the extension field and assigning, based on the business telemetry data, values to each of the one or more data types. The one or more data types may include at least a parameter associated with operations of the IoT device. Each of the values may include at least a value of the parameter. The one or more data types and the corresponding values may be stored in the extension field of the EDNS packet. In an example embodiment, the one or more data types may be stored as keys and, thus, the business telemetry data may be stored in the extension field of the EDNS packet in the form of key-value pairs where each pair is constituted by the parameter and the value of the parameter.

Referring again to FIG. 2, the method 200 may further include an operation 230, at which the EDNS packet may be routed to the business data center using the DNS protocol. In an example embodiment, the method 200 may further include encrypting the EDNS packet before routing the EDNS packet. For example, the encryption of the EDNS packet may be performed by an intermediate DNS server. Specifically, the intermediate DNS server may be located in the data network between the IoT device and the DNS server and may be responsible for the encryption of EDNS packets sent by the IoT device and decryption of EDNS packets sent to the IoT device.

In an example embodiment, the method 200 may include receiving, by the IoT device, a DNS query from the business data center to provide the business telemetry data. In this case, the IoT device may send the EDNS packet to the business data center as part of a DNS answer to the DNS query. The business data center may be hosted by a third-party service provider that provides services associated with the IoT device or by the manufacturer of the IoT device. Upon receipt of the business telemetry data by the DNS server associated with the business data center, the business telemetry data may be retrieved by the service provider from the EDNS packet received by the DNS server.

The method 200 may optionally include an operation 240, at which the IoT device may receive a DNS answer from the DNS server of the business data center. The DNS answer may include a further EDNS packet that includes the at least one extension field having at least an instruction associated with the IoT device. The service provider may issue and send the instruction based on the processing of the business telemetry data. In an example embodiment, the instruction may include one or more of the following: a request to send the business telemetry data, a command to activate an operation of the IoT device, a command to stop the operation of IoT device, a command to change one or more parameters of the operation of the IoT device, and so forth.

According to various embodiments, the IoT device does not need to establish a MQTT or an HTTP connection with the service provider; neither does the DNS server of the service provider need to send a DNS answer to the IoT device in response to receiving the EDNS packet from the IoT device. According to various embodiments, therefore, additional network bandwidth is not used for transmitting MQTT or HTTP packets or the DNS answer packets from the DNS server to the IoT device, Thus, the network bandwidth is not used to transmitting packets conventionally transmitted between the IoT device and the service provider in a data session, according to various embodiments.

Furthermore, a traditional data session with an IoT device via the MQTT or HTTP protocol requires using MQTT or HTTP libraries, respectively. The MQTT or HTTP libraries require more onboard storage for IoT devices, compute speed, and result in emission heat. The higher heat emission requires larger cooling equipment (heat-sink) and heat-tolerant chips that are more expensive. Therefore, replacing the MQTT or HTTP based business data transfer with the DNS business data transfer to transmit the business telemetry data, according to various embodiments, may save service providers costs related to hardware.

Method 200 according to various embodiments can be implemented without any additional infrastructure because it facilitates delivery of business telemetry data to the service provider using the DNS protocol which is part of the existing Transmission Control Protocol (TCP)/IP network infrastructure. Thus, usage of the DNS protocol in various embodiments for transmitting the business telemetry data results in little, if any, modification at a network firewall because ports are already open for the DNS protocol to perform its traditional functionality. Therefore, complexity in implementing IoT telemetry taxonomy mapping may be reduced by using the DNS protocol for transmitting the business telemetry data in various embodiments.

Additionally, operational and maintenance expenses for professional services in implementing telemetry services for the IoT infrastructure may be simplified and reduced, according to various embodiments of the present technology. Another of the advantages of the present technology according to various embodiments is that software implementation may be simplified and require lesser hardware demand, thereby providing for a cheaper hardware cost and lower operating temperature of the hardware. Additionally, hardware implementation may be simplified and, thus, a smaller housing (chassis) and less amount of cooling may be required. One less server/service may be needed to be operated/maintained by the service provider because there is no need to establish and maintain a MQTT or an HTTP data connection between the IoT device and the service provider.

In an example embodiment, entities that use the IoT devices may be provided with a subscription service for receiving the business telemetry data. The subscription service may include providing relevant contextual data to each entity subscribed for the subscription service.

In a further example embodiment, the usage of the DNS protocol for transmitting the business telemetry data may enable protecting the IoT devices from attacks and provide security mitigation for IoT devices directly from a command and control service that may result in less operations and maintenance at the firewall. Additionally, the usage of the DNS protocol for transmitting the business telemetry data, according to various embodiments, may enable localized remote-branch connection and activity visibility, content-blocking and phishing/malware protection, enterprise messaging, and deploying parallel architecture along-side existing IoT device/DNS server architecture.

According to various embodiments, the manufacturers of the IoT devices may implement business data transportation in EDNS fields of the DNS protocol and obtain the following benefits:

Security and Privacy Governance:

The manufacturers of the IoT devices may be able to gate (review and filter) the business application data before the business application data enter and exit a controlled network environment of the manufacturers. For example, the manufacturers may investigate whether business application data have an error or are compromised. For example, all smart-freezer units may be mistakenly set to 30 degrees Celsius instead of 30 degrees Fahrenheit. The manufacturers may correct this error upon review of the business application data. Another example may include determination that the IoT was compromised when it is determined, based on the analysis of the business application data, that the managed services have been overrun by a foreign assailant, which has sent out instructions to all smart-freezer units across the globe to set them to 30 degrees Celsius.

Data Transformation and Integration:

The manufacturers of the IoT devices may be able to link the external web services, organizational business systems, and operation schematic that manage the smart-devices. For example, the analysis of the business application data contained in the EDNS packet may be used to:
Transform calendar format: from (mm/dd/yyyy) to (dd-MMM-yyyy).
Set settings for a corporate holiday: An organization may declare that a certain day is a holiday. Therefore, the manufacturer may override the need to trigger all six thousand smart-fridge and smart-freezer units across the country for the pre-action “to cool the fridge and freezer at local time between 10 am to 12 pm”.
National Weather Web-services and Power-Utility Web-services integration:
   i. [T-1] Current time at 8 am; the weather web-services predicted a heat wave tomorrow at 11 am;
   ii. [T-1] At 9 am, organizational calendar accepted the suggestion to reorganize labor workforce to process re-stocking on inventory today 6 pm to 9 pm instead of tomorrow at 9 am to 12 pm;
   iii. [T-0] Power-Utility web-services distribute the electrical grid to a lower cost per unit to cool the smart-fridges and smart-freezer at Location-A and Location-C between (9 am to 9.30 am), alternate to Location-B and Location-D between (9.30 am to 10 am), then Location-A and Location-C between (10 am to 10.15 am), then back to Location-B and Location-D between (10.15 am to 10.30 am), switch the smart-freezer and smart-fridges in Location-A, B, C, D to energy saving mode where applicable.
   iv. [T-0] Making Location-E and Location-F as the shipping primaries for today between (10.30 am onwards).
   v. [T-0] Respond to any shipping request only from City-E and City-F between 11 am to 5 pm.

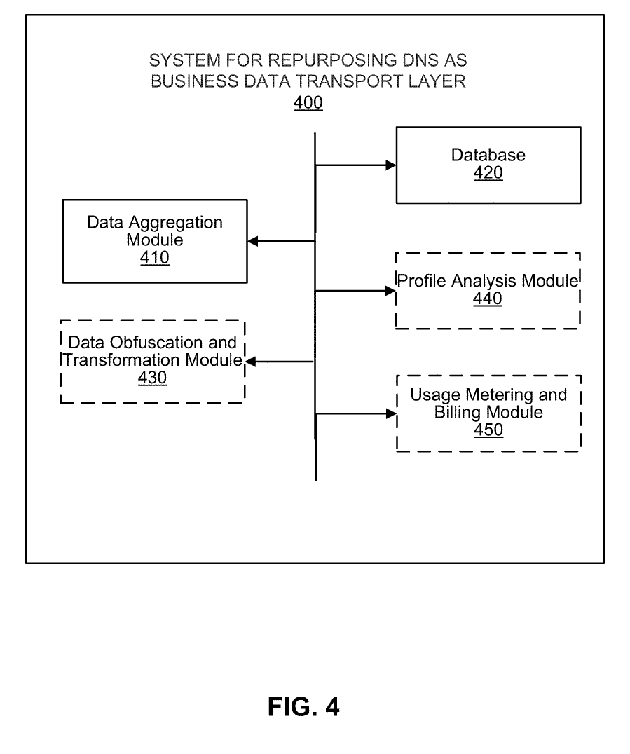

FIG. 4 shows a block diagram illustrating various modules of a system 400 for repurposing a DNS as a business data transport layer, according to an example embodiment. The system 400 may serve as a business telemetry engine 150 shown on FIG. 1. Specifically, the system 400 may include a data aggregation module 410, a database 420, and, optionally, a data obfuscation and transformation module 430, a profile analysis 440, and a usage metering and billing module 450. The system 400 may be connected to a DNS server. The DNS server may be associated with a business data center. The business data center may be hosted by a service provider associated with IoT devices. The data aggregation module 410 may receive, from the DNS server associated with the business data center, an EDNS packet forwarded to the DNS server by at least one telemetry sensor installed on an IoT device. The EDNS packet may include a DNS address associated with the business data center and business telemetry data stored in at least one extension field of the EDNS packet. The business telemetry data may be associated with the IoT device. The data aggregation module 410 may retrieve the business telemetry data from the EDNS packet and store the business telemetry data associated with the IoT device to the database 420. The database 420 may be configured to store at least the business telemetry data associated with the IoT device.

In an example embodiment, upon receipt of the business telemetry data, the data aggregation module 410 may send a DNS answer to the IoT device. The DNS answer may include a further EDNS packet including the at least one extension field. The at least one extension field may have at least an instruction associated with the IoT device. The instruction may include one or more of the following: a request to send the business telemetry data, a command to activate an operation of the IoT device, a command to stop the operation of IoT device, a command to change one or more parameters of the operation of the IoT device, and so forth.

In a further example embodiment, before receiving any business telemetry data from the IoT, the data aggregation module 410 may send, to the IoT device, a DNS query to provide the business telemetry data. Therefore, the EDNS packet may be received from the IoT device as part of a DNS answer to the DNS query of the data aggregation module 410. In this case, the extension field of the DNS query may include a request for the IoT to send the business telemetry data to the system 400.

The system 400 may further include a data obfuscation and transformation module 430. The data obfuscation and transformation module 430 may perform operations relating to providing security of business telemetry data, censorship, privacy, transformation, language-regional translation, and key-value mapping. In an example embodiment, the data obfuscation and transformation module 430 may be configured to decrypt the EDNS packet received from the IoT device and encrypt the EDNS packet to be sent to the IoT device.

The system 400 may further include a profile analysis module 440. The profile analysis module 440 may be configured to classify the business telemetry data associated with the IoT device. The classification may be performed based on predetermined parameters. The profile analysis module 440 may be configured to determine, based on the classification, usage patterns for the IoT device. The usage pattern may illustrate modes of operation of the IoT device, power consumption, and so forth. Based on the usage patterns associated with the IoT device, the profile analysis module 440 may perform a predictive qualitative modeling of an operation of the IoT device. The taxonomy of usage-patterns may be used for grouping services provided using the IoT devices (e.g., setting the same parameters for the group of IoT devices located at the same location).

The system 400 may further include a usage metering and billing module 450. The usage metering and billing module 450 may be configured to meter a network bandwidth associated with an operation of the IoT device. For example, the usage metering and billing module may meter power consumed by the IoT device for a predetermined time. The usage metering and billing module 450 may be configured to issue an invoice for a user associated with the IoT device and manage payments received from the user associated with the IoT device. The usage metering and billing module 450 may be configured to perform operations related to profit sharing, freeware, periodical licensing, perpetual licensing related to the IoT devices, and so forth.

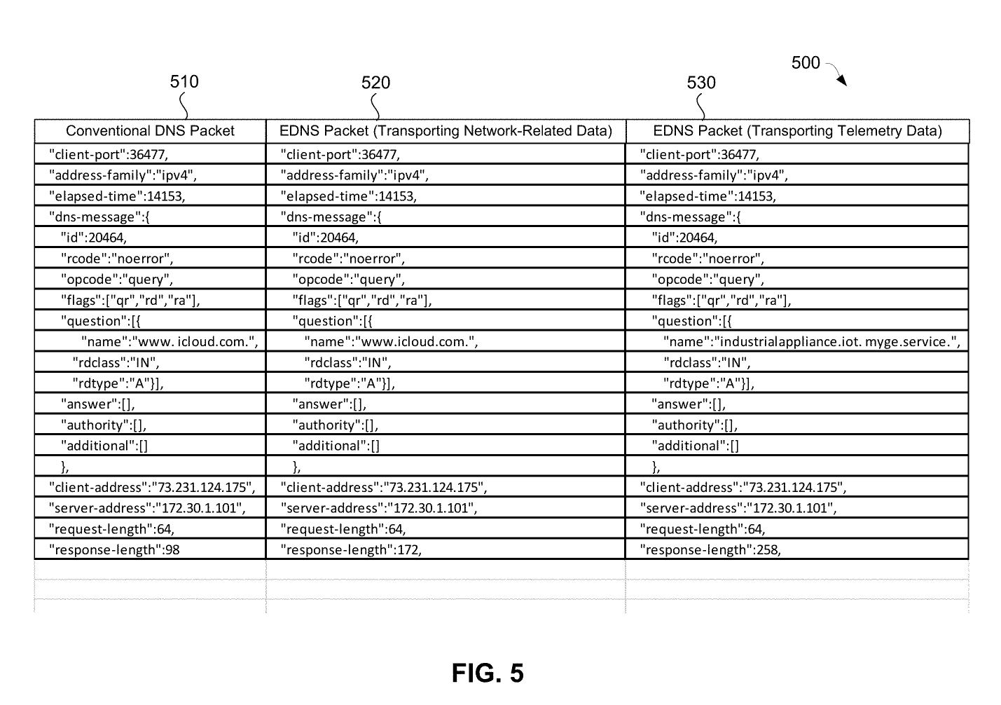

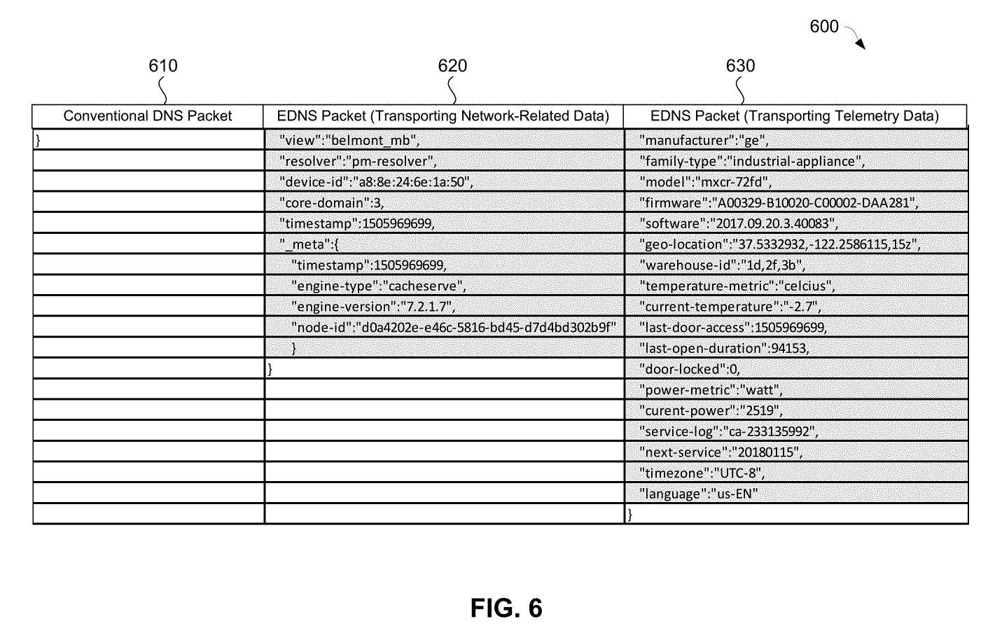

FIG. 5 and FIG. 6 show schematic representations 500 and 600, respectively, of comparison, side-by-side, of a conventional DNS packet, an EDNS packet having an extension field used for transporting network-related data, and an EDNS packet having an extension field used for transporting telemetry data, according some example embodiments.

The DNS packet shown in column 510 of FIG. 5 is a conventional DNS packet without an EDNS field. Column 510 shows all fields of the conventional DNS packet. As shown in FIG. 6, column 610 is empty, i.e., the conventional DNS packet does not have an extension field.

Column 520 of FIG. 5 shows an EDNS packet, i.e., a DNS packet having an EDNS field. The EDNS field is an extension field of the EDNS packet and is conventionally used for transporting network-related data. FIG. 6 shows column 620 with the extension field of the EDNS packet. The extension field shown in column 620 contains network-related data. Transportation of network-related data in the extension field of the EDNS is commonly used in the networking industry. In an example embodiment, the network-related data may include an identification (ID) number of a device, a timestamp, an engine type, an engine version, a node ID number, and so forth.

In this example embodiment in FIG. 5, column 530 shows an EDNS packet having an extension field used for transporting business telemetry data. The example in FIG. 6 shows column 630 with the extension field of the EDNS packet. The extension field shown in column 630, in this example, contains business telemetry data. In an example embodiment, the business telemetry data may include a name of manufacturer, a family type of an industrial appliance, a model of a device, a firmware version and a software version installed on the device, a geographical location of the device, a warehouse ID, a temperature metric, a current temperature, a last door access, a last opening duration, a door locked/open code, a service log, a next service date, a time zone, a language code, and so forth.

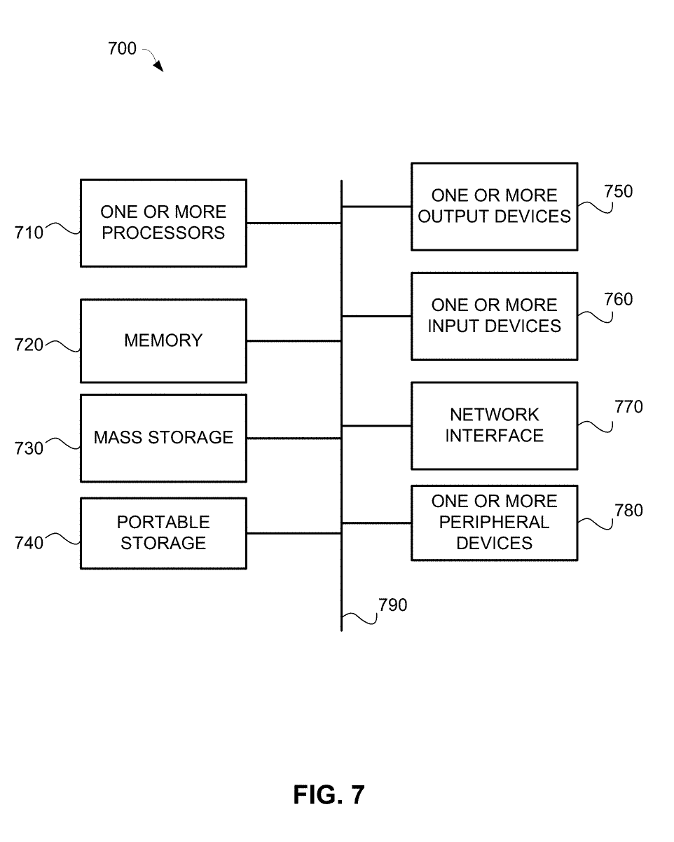

FIG. 7 illustrates an exemplary computing system 700 that may be used to implement embodiments described herein. The exemplary computing system 700 of FIG. 7 may include one or more processors 710 and memory 720. Memory 720 stores, in part, instructions and data for execution by the one or more processors 710. Memory 720 can store the executable code when the exemplary computing 700 is in operation. The exemplary computing 700 of FIG. 7 may further include a mass storage 730 device, portable storage 740, one or more output devices 750, one or more input devices 760, a network interface 770, and one or more peripheral devices 780.

The components shown in FIG. 7 are depicted as being connected via a single bus 790. The components may be connected through one or more data transport means. The one or more processors 710 and memory 720 may be connected via a local microprocessor bus, and the mass storage 730, peripheral device(s) 780, portable storage 740, and network interface 770 may be connected via one or more input/output (I/O) buses.

Mass storage 730, which may be implemented with a magnetic disk drive or an optical disk drive, is a non-volatile storage device for storing data and instructions for use by a magnetic disk or an optical disk drive, which in turn may be used by processor 710. Mass storage 730 can store the system software for implementing embodiments described herein for purposes of loading that software into memory 720.

Portable storage 740 operates in conjunction with a portable non-volatile storage medium, such as a compact disk (CD) or digital video disc (DVD), to input and output data and code to and from the computer system 700 of FIG. 7. The system software for implementing embodiments described herein may be stored on such a portable medium and input to the computer system 700 via the portable storage 740.

One or more input devices 760 provide a portion of a user interface. The one or more input devices 760 may include an alphanumeric keypad, such as a keyboard, for inputting alphanumeric and other information, or a pointing device, such as a mouse, a trackball, a stylus, or cursor direction keys. Additionally, the system 700 as shown in FIG. 7 includes one or more output devices 750. Suitable one or more output devices 750 include speakers, printers, network interfaces, and monitors.

Network interface 770 can be utilized to communicate with external devices, external computing devices, servers, and networked systems via one or more communications networks such as one or more wired, wireless, or optical networks including, for example, the Internet, intranet, LAN, WAN, cellular phone networks (e.g., Global System for Mobile communications network, packet switching communications network, circuit switching communications network), Bluetooth radio, and an IEEE 802.11-based radio frequency network, among others. Network interface 770 may be a network interface card, such as an Ethernet card, optical transceiver, radio frequency transceiver, or any other type of device that can send and receive information. Other examples of such network interfaces may include Bluetooth®, 3G, 4G, and WiFi® radios in mobile computing devices as well as a USB.

One or more peripheral devices 780 may include any type of computer support device to add additional functionality to the computer system. The one or more peripheral devices 380 may include a modem or a router.

The components contained in the exemplary computing system 700 of FIG. 7 are those typically found in computer systems that may be suitable for use with embodiments described herein and are intended to represent a broad category of such computer components that are well known in the art. Thus, the exemplary computing system 700 of FIG. 7 can be a personal computer (PC), hand held computing device, telephone, mobile computing device, workstation, server, minicomputer, mainframe computer, or any other computing device. The computer can also include different bus configurations, networked platforms, multi-processor platforms, and so forth. Various operating systems (OS) can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the example embodiments. Those skilled in the art are familiar with instructions, processor(s), and storage media.

It is noteworthy that any hardware platform suitable for performing the processing described herein is suitable for use with the example embodiments. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as RAM. Transmission media include coaxial cables, copper wire, and fiber optics, among others, including the wires that include one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-read-only memory (ROM) disk, DVD, any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Thus, various embodiments of methods and systems for repurposing a DNS as a business data transport layer have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense. There are many alternative ways of implementing the present technology. The disclosed examples are illustrative and not restrictive.

What is claimed is:

1. A method for repurposing a domain name system (DNS) as a business data transport layer, the method comprising:
collecting, by at least one telemetry sensor installed on an Internet of Things (IoT) device, business telemetry data associated with the IoT device;
generating, by the IoT device, an Extended DNS (EDNS) packet, the EDNS packet including a DNS address associated with a business data center and the business telemetry data stored in at least one extension field of the EDNS packet; and
generating, by the IoT device, a DNS request to route the EDNS packet to a DNS server associated with the business data center.

2. The method of claim 1, further comprising receiving a DNS query from the DNS server associated with the business data center to provide the business telemetry data, the EDNS packet being provided as part of a DNS answer to the DNS query.

3. The method of claim 1, wherein the business data center is hosted by a service provider supporting the IoT device.

4. The method of claim 1, wherein upon receipt of the EDNS packet by the DNS server associated with the business data center, the business telemetry data are retrieved from the EDNS packet and processed by the business data center.

5. The method of claim 1, wherein the storing of the business telemetry data in the at least one extension field of the EDNS packet includes:
selecting one or more data types to be included in the at least one extension field;
assigning values to the one or more data types; and
storing the one or more data types and corresponding values in the at least one extension field.

6. The method of claim 5, wherein each of the one or more data types includes at least a parameter associated with an operation of the IoT device, and wherein each of the values includes at least a value of the parameter.

7. The method of claim 1, wherein the business telemetry data include one or more of the following: an Internet Protocol (IP) address of the IoT device, an identification number of the IoT device, a parameter code of the IoT device, a value of a current parameter of the IoT device, a model of the IoT device, a firmware version of the IoT device, data concerning a quality assurance center associated with the IoT device, an operation start time, an operation stop time, a troubleshooting code, a geographical location of the IoT device, a brand of the IoT device, a price of the IoT device, a color of the IoT device, a temperature of the IoT device, a date, and a timestamp.

8. The method of claim 1, wherein the EDNS packet comprises a header, a question field, an answer field, an authority field, and the at least one extension field.

9. The method of claim 1, further comprising encrypting the EDNS packet.

10. The method of claim 1, further comprising receiving, by the IoT device, a DNS answer from the DNS server of the business data center, the DNS answer including a further EDNS packet comprising the at least one extension field having at least an instruction for the IoT device.

11. The method of claim 10, wherein the instruction includes one or more of the following: a request to send the business telemetry data, a command to activate an operation of the IoT device, a command to stop the operation of IoT device, and a command to change one or more parameters of the operation of the IoT device.

12. A system for repurposing a domain name system (DNS) as a business data transport layer, the system comprising:
a data aggregation module configured to:
receive, via a DNS server associated with a business data center, an Extended DNS (EDNS) packet routed to the DNS server from at least one telemetry sensor installed on an Internet of Things (IoT) device, the EDNS packet including a DNS address associated with the business data center and business telemetry data stored in at least one extension field of the EDNS packet, the business telemetry data being associated with the IoT device; and
retrieve the business telemetry data from the EDNS packet; and
a database configured to store at least the business telemetry data associated with the IoT device.

13. The system of claim 12, wherein the data aggregation module is further configured to send, to the IoT device, a DNS query, wherein an answer to the DNS query is to include the business telemetry data in the EDNS packet.

14. The system of claim 12, wherein the data aggregation module is further configured to send a DNS answer to the IoT device, the DNS answer including a further EDNS packet comprising the at least one extension field having at least an instruction associated with the IoT device.

15. The system of claim 14, wherein the instruction includes one or more of the following: a request to send the business telemetry data, a command to activate an operation of the IoT device, a command to stop the operation of IoT device, and a command to change one or more parameters of the operation of the IoT device.

16. The system of claim 14, further comprising a data obfuscation and transformation module configured to:
decrypt the EDNS packet; and
encrypt the further EDNS packet.

17. The system of claim 12, further comprising a profile analysis module configured to:
classify the business telemetry data associated with the IoT device;
based on the classifying, determine usage patterns for the IoT device; and
based on the usage patterns associated with the IoT device, perform a predictive qualitative modeling of operations of the IoT device.

18. The system of claim 12, further comprising a usage metering and billing module configured to:
meter a network bandwidth associated with an operation of the IoT device;
issue an invoice for a user associated with the IoT device; and
manage payments received from the user associated with the IoT device.

19. The system of claim 12, wherein the business telemetry data include one or more of the following: an Internet Protocol (IP) address of the IoT device, an identification number of the IoT device, a parameter code of the IoT device, a value of a current parameter of the IoT device, a model of the IoT device, a firmware version of the IoT device, data concerning a quality assurance center associated with the IoT device, an operation start time, an operation stop time, a troubleshooting code, a geographical location of the IoT device, a brand of the IoT device, a price of the IoT device, a color of the IoT device, a temperature of the IoT device, a date, and a timestamp.

20. A non-transitory processor-readable medium having instructions stored thereon, which when executed by one or more processors, cause the one or more processors to implement a method for repurposing a domain name system (DNS) as a business data transport layer, the method comprising:
collecting, by at least one telemetry sensor installed on an Internet of Things (IoT) device, business telemetry data associated with the IoT device;
generating, by the IoT device, an Extended DNS (EDNS) packet, the EDNS packet including a DNS address associated with a business data center and the business telemetry data stored in at least one extension field of the EDNS packet; and
generating, by the IoT device, a DNS request to route the EDNS packet to a DNS server associated with the business data center.
